(19) United States
(12) Patent Application Publication
(10) Pub. No.: US 2005/0151863 A1
(43) Pub. Date: Jul. 14, 2005

(54) Arrangement in a measuring system

(75) Inventors: Mattias Johannesson, Linkoping (SE); Anders Murhed, Linkoping (SE)

Correspondence Address: VENABLE LLP, P.O. BOX 34385, WASHINGTON, DC, 20435-9998, US

(73) Assignee: IVP Integrated Vision Products AB, Linkoping (SE)

(21) Appl. No.: 10/510,208

(22) PCT Filed: Mar. 19, 2003
(86) PCT No.: PCT/SE03/00461

(30) Foreign Application Priority Data
Apr. 5, 2002 (SE) 0201044-5

(51) Int. Cl. H04N 5/335

(52) U.S. Cl. 348/294

(57) ABSTRACT

System and sensor (10) for imaging characteristics of an object (2). The sensor comprises at least a first area (11) and a second area (12) of pixel elements arranged to absorb electromagnetic radiation from the object (2) and to convert the radiation absorbed into electrical charges. The first area (11) has a first degree of resolution and the second area (12) has a second degree of resolution different from the first degree of resolution and the first area (11) is arranged to image one type of characteristics and the second area (12) is arranged to image another type of characteristics.

### TECHNICAL FIELD

The present invention relates in general to a sensor and a system for imaging characteristics of an object and relates in particular to a sensor and system for imaging multiple characteristics of an object with different degrees of resolution.

### PRIOR ART

Conventional imaging sensors of the charge coupled device (CCD) and complementary metal oxide semiconductor (CMOS) type have an N×M matrix (array) with photodiodes, which absorb electromagnetic radiation and convert this into electrical signals.

There is often a requirement for imaging multiple characteristics of the same object, such as various three-dimensional (3D) and two-dimensional (2D) characteristics. In the 3D image geometrical characteristics such as width, height, volume etc. of the object are imaged. In the 2D image characteristics such as cracks, structural orientation, position and identity are imaged, for example, through marks, bar code or matrix code. Intensity information in the 2D image is usually imaged in grey scale, but imaging the 2D image in colour, that is to say registering R (red), G (green) and B (blue) components, for example, by means of filters or light wavelengths is also common.

A matrix array picture processor (MAPP sensor) is used for Imaging different characteristics of the same object using the same sensor, so-called multisensing, by using a part of the sensor for laser profiling (3D measurement) and individual sensor rows for reading out intensity information (2D measurement). An advantage in using one sensor to image multiple characteristics is that the cost and complexity of the system are less than when using one sensor for the 3D measurement and another sensor for the 2D measurement, for example.

In multisensing, the same resolution is nowadays used for lateral measurement both in the 2D measurement and in the 3D measurement. It is usual, however, to require a higher resolution on the 2D image than on the 3D image. The reason for this is the desire to be able to measure finer detail in the image than is required in measurement of the shape. An example of this is timber inspection, where it is often more important to measure cracks and surface structure with a higher resolution than the geometric shape.

Examples of imaging sensors which have different degrees of resolution are shown in Alireza Moini “Vision chips”, Kluwer Academic Publishers, page 143-146, 2000, in which image sensors are constructed as an electronic eye, that is to say they have a high resolution in the centre and a low resolution at the periphery. The pixel geometry in these “eyes” is linear-polar or log-polar. If the “eye” sees something interesting at its periphery with a low resolution, the system can control the sensor so that it directs its high-resolution centre part to the area in order to read the details. This type of sensor is very well suited for robot applications. An example of such an electronic eye is also shown in U.S. Pat. No. 5,166,511.

Another example of an imaging sensor which has different degrees of resolution is shown in U.S. Pat. No. 6,320,618, in which an array matrix-type sensor has been provided with at least one area having a higher resolution than the rest of the sensor. The sensor is placed in a camera, which is mounted on a vehicle as a part of an automatic navigation system, which controls functions of the vehicle, for example braking if some obstacle appears in front of the car or steering along the white line at the edge of the road. The sensor is arranged to pick up remote information with a high resolution and information in proximity to the vehicle with a low resolution.

### SUMMARY OF THE INVENTION

An object of the present invention is to provide a sensor and a system which image the characteristics of an object with different degrees of resolution. This has been achieved by a sensor and a system having the characteristics specified in the characterising parts of claims 1 and 9 respectively.

One of the advantages to the use of a sensor and a system which read in multiple characteristics images with different degrees of resolution is that a simpler, cheaper and more compact solution is obtained than with previously known solutions. A system according to the invention furthermore requires fewer system components such as cameras, lenses etc.

According to one embodiment of the present invention the sensor comprises two integral areas with pixels which are arranged substantially parallel, side by side in a transverse direction.

According to another embodiment of the invention the two areas with pixels are designed as two separate units, which are arranged substantially parallel, side by side in a transverse direction

According to a further embodiment of the invention the two pixel areas/units share read-out logic, which means that they have the same output register.

According to an alternative embodiment of the invention the two pixel areas/units are each read out on different output registers, which means that it is possible to read out the information contained in the two areas/units simultaneously. One advantage to this is that it obtains greater freedom with regard to exposure times. Another advantage is that it obtains greater freedom with regard to degrees of resolution in both the transverse direction and the lateral direction.

### BRIEF DESCRIPTION OF THE DRAWINGS

The invention will now be explained in more detail on the basis of examples of embodiments and with reference to the drawings attached in which:

FIG. 1 shows a perspective view of a measuring system according to the present invention;

FIG. 2 shows a three-dimensional profile and intensity profile of an object imaged on the sensor;

FIG. 3 shows a first embodiment of a sensor according to the invention;

FIG. 4 shows a second embodiment of a sensor according to the invention;

FIG. 5 shows an alternative embodiment of a sensor according to the invention;

FIG. 6 illustrates a fundamental system setup according to a first embodiment;

FIG. 7 illustrates a fundamental system setup according to a second embodiment.

### DETAILED DESCRIPTION OF EMBODIMENTS

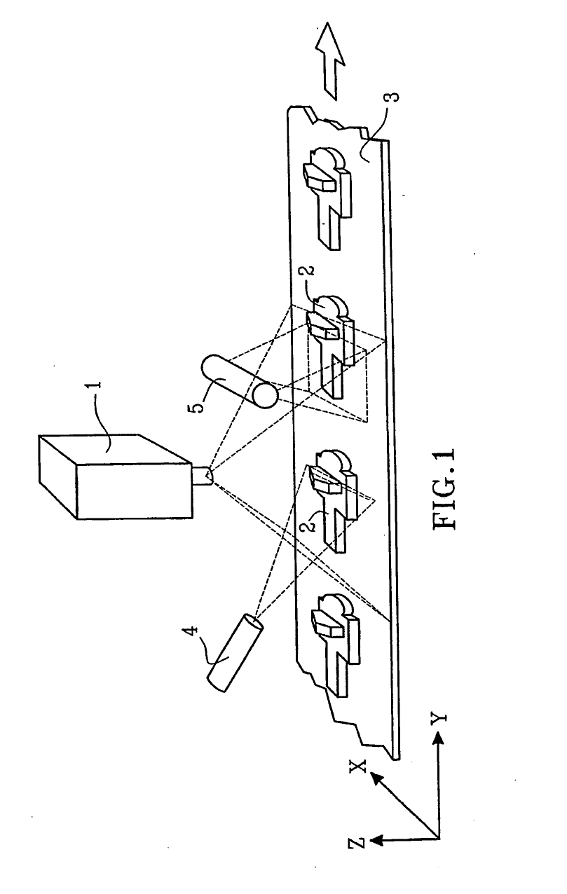

FIG. 1 shows a system for reading in characteristics of an object. The system comprises a camera 1, which may be an MAPP camera, a CCD camera, a CMOS camera or any other camera suitable for imaging characteristics of an object. The system further comprises an object 2, the characteristic-dependent parameters of which are to be measured by the system, placed on a base 3 together with two light sources 4 and 5 arranged to illuminate the object 2. The light sources 4, 5 generate, for example, substantially point light, substantially linear light or light composed of multiple, substantially point or linear segments and may be of any type suited to the application, for example lasers, LED's, ordinary light (light bulb) etc, but these are familiar to the person skilled in the art and will not be further described here.

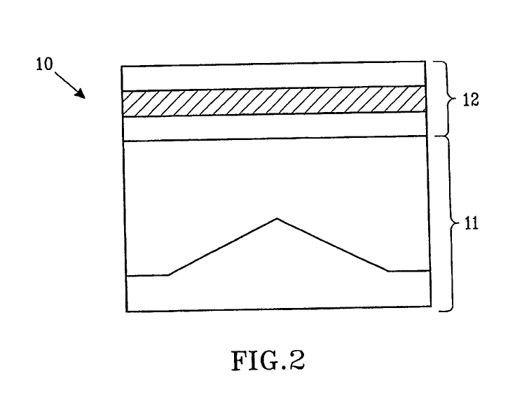

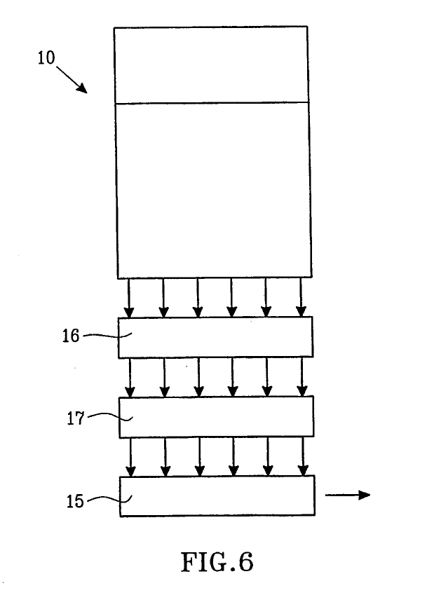

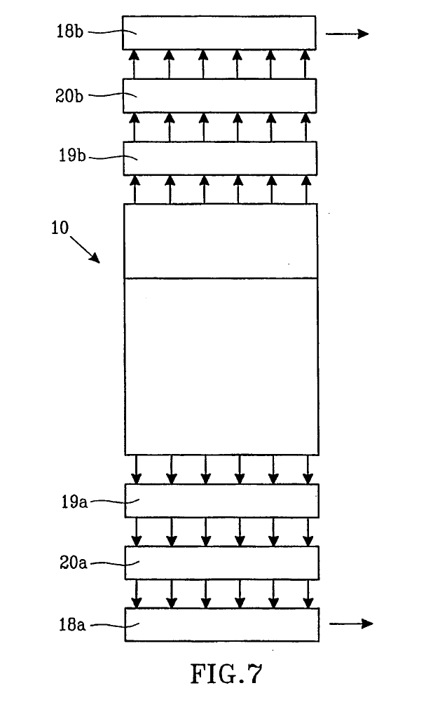

The camera 1 comprises, among other things, a sensor 10, which is shown in FIGS. 2 to 5 and is described in more detail below, light-gathering optics and control logic (not shown). The rays reflected from the object 2 are picked up by the sensor 10 and are converted there into electrical charges, which are in turn converted into analog or digital electrical signals. In the preferred embodiment these signals are then transferred via an output register (shown in FIGS. 6 and 7) to an image/signal-processing unit (not shown) to be analysed and processed.

The object 2, which as stated above, has been placed on the base 3, which in a preferred embodiment moves relative to the measuring system indicated by an arrow in the figure. Instead of the base 3 moving relative to the measuring system, the relationship may naturally be reversed, that is to say the object 3 is fixed and the measuring system moves over the object 2 when measuring. The base 3 may be a conveyor belt, for example, or alternatively there is no base and the object itself moves, if the said object is paper, for example, in a continuous web in a paper-making machine.

In an alternative embodiment (not shown), one or more of the light sources is located below the base 3 and shines through the object 2, which means that the sensor 10 picks up transmitted rays which have passed through the object 2, and not reflected rays.

In FIG. 1 the direction of movement is indicated by an arrow. This direction will be referred to in this document as the transverse direction, that is to say Y in the system of coordinates drawn into the figure. The lateral direction (X in the system of coordinates) lies perpendicular to the transverse direction. In measuring there is a transverse and a lateral resolution. The transverse resolution depends on how frequently the object 2 is read off (sampled). The present invention is primarily concerned with the lateral resolution, which largely depends on the number of pixels which the sensor 10 has in a row.

The sensor 10 (shown in FIGS. 2 to 5) is an array sensor and has a first area 11 with N×M pixels (where N is rows and M is columns) combined with a second high-resolution area 12 with X×Y pixels, where Y=M×b (b is an integer >1). In the preferred embodiment the first area 11 is used for 3D measurement by tri-angulation, that is to say imaged geometric characteristics of the object 2 such as width, height, volume etc. In 3D measurement, the intensity image is reduced from k rows, k>1, to the position values that correspond to where the light strikes the sensor in each column. The result is a profile with three-dimensional information for each sample of k rows. In the preferred embodiment the second area 12 is used for 2D measurement (intensity information), that is to say in imaged characteristics of the object 2 such as cracks, structural orientation, position etc. If X>2, there is a possibility of applying colour filters (for example, RGB) to the individual pixels and in this way obtaining a colour read-out of 2D data.

FIG. 2 shows a 3D profile of the object 2 in the first area 11 and a grey scale/colour image of the object 2 in the second area 12. The object 2 is scanned profile by profile as the object 2 passes the measuring system and the result is accordingly a three-dimensional and a two-dimensional imaging of the object 2.

In the preferred embodiment an MAPP sensor is used, but the person skilled in the art will appreciate that the invention may be applied to other types of sensors, such as CCD sensors or CMOS sensors, for example.

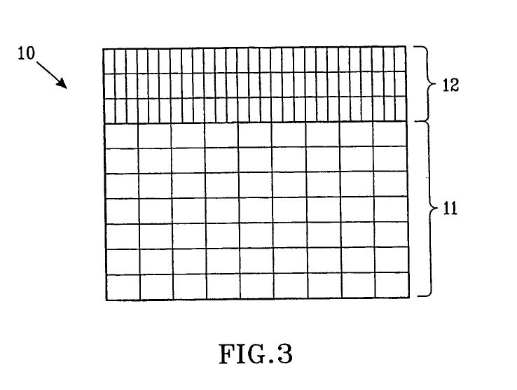

FIG. 3 shows a first embodiment of the sensor according to the invention. Here the pixels in the second area 12 are one third the width of the pixels in the first area 11. If there are 512×1536 pixels in the first area 11, for example, the second area 12 then has 16×4608 pixels (b=3), for example. This means that up to 512 rows are used for the 3D measurement and triple resolution intensity components are read out on up to 16 rows.

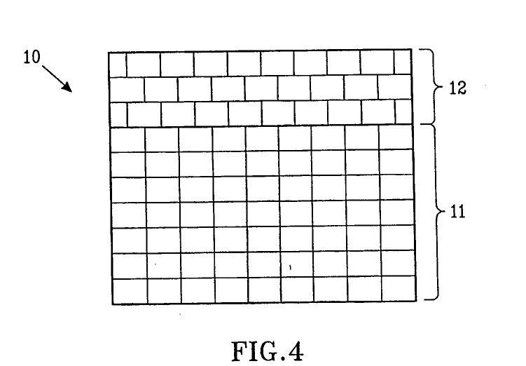

In the embodiment according to FIG. 4 every other row in the second high-resolution area 12 is offset half a pixel width in relation to the rows immediately below and above. The second area 12, according to the example for FIG. 3, then has 8×3072 double rows of pixels (b=2), in which a double row consists of two single rows and one row is offset by half a pixel width. This means that in the embodiment according to FIG. 4 up to 512 rows are used for 3D measurement and up to 8 different double-resolution intensity components are read out.

The person skilled in the art will appreciate that the invention is not limited to the embodiments shown in FIGS. 3 and 4. There is an almost infinite number of variants of how the pixels can be formed in the high-resolution second area 12. For example, the pixels may be half the width of those in the first area 11, or also at the same time twice as high etc. Other variants of the embodiment according to FIG. 4 may involve the pixels being offset by a third or a quarter of the pixel width. With regard to this, see also U.S. Pat. No. 4,204,230, which shows offset pixel rows for increasing the resolution of an imaging sensor.

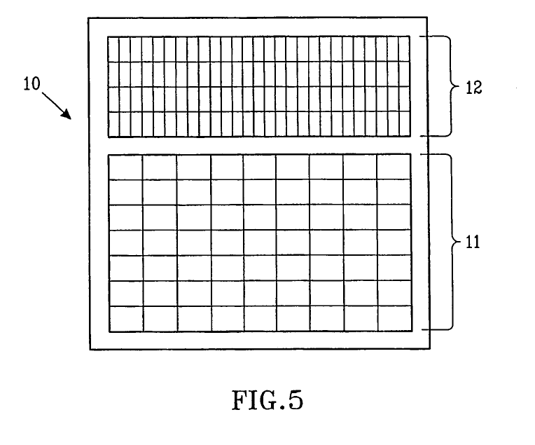

According to FIGS. 3 and 4 the first area 11 and the second area 12 lie substantially parallel side by side in direct contact in a transverse direction, that it to say the sensor is manufactured as an integral unit. FIG. 5 shows an alternative embodiment in which the first area 11 and the second area 12 are two separate units lying substantially parallel side by side in the transverse direction, but not in direct contact. In FIGS. 2 to 5 the second high-resolution area 12 is located transversely in front of the first area 11 (illustrated at the top of the figures), but naturally it may equally well be located transversely behind the first area 11 (illustrated at the bottom of the figures).

An alternative to designing the pixels offset in relation to one another is to cover the pixels with masks, which are arranged in such a way that illumination of parts of pixels is blocked and an offset sampling pattern is thereby obtained.

A sensor row is read out to an output register, which is M pixels long, shown in FIGS. 6 and 7. This output register 15, 18a, 18b is either exchanged as raw data or it is coupled to a row-parallel A/D converter and/or signal/image processing unit. In order to read out a Y-wide row, w read-outs must be performed successively. If the output register 15, 18a, 18b has space for b rows, these can be read out/processed together. The read-out can therefore be both analog and digital, but in the preferred embodiment of the present invention (shown in FIG. 6), measured data is read out via an A/D converter 16 and a processor 17 to a digital output register 15, before being relayed to an image-processing unit 5 (not shown).

The processor 17 can be programmed to perform many functions, among other things extracting the three-dimensional profile from the intensity image, that is to say each column calculates the position of the lightest point and these values can then be seen as an intensity profile in which the intensity corresponds to distance. Other functions performed by the processor 17 are edge detection, noise reduction etc.

In an alternative embodiment of the invention, shown in FIG. 7, the two sensor areas 11, 12 (N×M and X×Y) do not share the read-out logic, that is to say they have different output registers 18a and 18b, which means that other effects are obtained. Information from the two areas 11, 12 can be read out independently of one another with greater freedom of exposure times and degrees of resolution both in the transverse and in the lateral direction. Furthermore, Y=M×b need not apply, it being instead possible to configure the geometries differently, for example a 1536×512 matrix could be combined with a 4096×3 matrix. In a preferred embodiment of the alternative embodiment shown in FIG. 7, measured data are read out via A/D converters 19a, 19b and processors 20a, 20b to digital output registers 18a, 18b.

Both of the embodiments according to FIGS. 6 and 7 are illustrated with A/D converters and processors. These should only be regarded as preferred embodiments. It is quite possible, as briefly mentioned above, to output measured data directly as analog or digital raw data from the output registers.

As stated above, it is possible to use colour filters or coloured light sources (not shown) on the second area 12 of the sensor 10, which means that both grey scale and colour images can be read out with the higher resolution. Which colour filters or coloured light sources are used and how these are placed will be known to the person skilled in the art and will not be described in detail here, but the possible use of Bayer patterns or a filter for each row may be mentioned by way of example. RGB components are commonly chosen, but other colours such as CMY (cyan magenta yellow) may also be used. In the alternative embodiment according to FIG. 7, each colour might have its own output register, which gives a faster read-out of each colour profile.

Crosstalk means that light from one measurement interferes with another sensor area, that is to say light from the 3D measurement interferes with the 2D measurement and/or vice-versa. In order to reduce the crosstalk between different sensor areas it is possible to separate the light to these into different wavelengths and to protect different sensor areas with optical filters differing according to wavelength, which block the light or allow it to pass through to the respective sensor area.

In yet another embodiment of the sensor 1 according to the invention time delay integration (TDI) is used on the high-resolution second area 12. TDI means that the charge is moved from one row to another as the object 2 is moved with the base 3, thereby achieving an X-times greater light sensitivity with X TDI stages. By using TDI in the embodiment according to FIG. 4, the charge will be moved by two rows per stage since intervening rows are offset by half the pixel width.

1. A sensor, comprising at least a first area and a second area of pixel elements arranged to absorb electromagnetic radiation from an object, the characteristics of which are to be imaged, and to convert the radiation absorbed into electrical charges, in which the first area has a first degree of resolution and the second area has a second degree of resolution different from the first degree of resolution, the first area is arranged to image one type of characteristics and the second area is arranged to image another type of characteristics.

2. The sensor according to claim 1, wherein the first area is arranged to image three-dimensional characteristics of the object and that the second area is arranged to image two-dimensional characteristics of the object.

3. The sensor according to claim 1, wherein at least one of the two areas is provided in its entirety or partially with color filters in order to image the object in color.

4. The sensor according to claim 1, wherein the first area is designed as a matrix having N rows and M columns, that the second area is designed as a matrix having X rows and Y columns and that Y is b multiplied by M columns, where b is an integer greater than zero.

5. The sensor according to claim 4, wherein time delay integration is used on the second area.

6. The sensor according to claim 1, wherein at least one of the areas is provided with filters for different wavelengths in order to minimize crosstalk.

7. The sensor according to claim 1, wherein the first area and the second area are arranged parallel in a transverse direction as one integral unit.

8. The sensor according to claim 1, wherein the first area and the second area are arranged parallel in a transverse direction as two separate units.

9. A system for measuring character-dependent parameters of an object comprising at least one light source which emits light towards the object, wherein the system further comprises a sensor according to claim 1, arranged to absorb electro-magnetic radiation from the object and to convert it into electrical charges.

10. The system according to claim 9, wherein the system also comprises an output register arranged to read out the charges received in the sensor.

11. The system according to claim 9, wherein the system also comprises at least two output registers arranged to read out the charges received in the sensor.

12. The sensor according to claim 11, wherein the first area and the second area of the sensor are each read out on their own output register.

13. The sensor according to claim 11, wherein if the second area of the sensor is provided with color filters, color picked up has its own output register.

14. The system according to claim 10, wherein the system further comprises an A/D converter arranged to convert the electrical charges from an analog to a digital format and that the output register is a digital output register.

15. The system according to claim 9, wherein the system also comprises an image/signal processing unit arranged to alanyze the electrical charges.
